(19) United States
(12) Patent Application Publication
(10) Pub. No.: US 2010/0015964 A1
(43) Pub. Date: Jan. 21, 2010

(54) Method and System for Call Switching During Multi-Party Calling

(75) Inventor: Dong Hyuk An, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/460,257

(22) Filed: Jul. 16, 2009

(30) Foreign Application Priority Data
Jul. 17, 2008 (KR) 10-2008-0069370

(51) Int. Cl. H04M 3/42

(52) U.S. Cl. 455/415; 455/416

(57) ABSTRACT

A method and system for call switching during multi-party calling are disclosed. The method of call switching during multi-party calling includes: receiving, by a base station, a call switch request signal from a first mobile terminal; placing, by the base station in response to the call switch request signal, a second mobile terminal in call active state from call waiting state as to the first mobile terminal, and sending a call switch response signal containing number digit information of the second mobile terminal to the first mobile terminal; and extracting, by the first mobile terminal, number digit information contained in the received call switch response signal, and displaying the number digit information on a display unit. The call switch response signal further includes an indication of number digit inclusion. Hence, the user of a mobile terminal can visually identify the counterpart through a displayed phone number.

### CROSS-REFERENCE TO RELATED APPLICATION(S) AND CLAIM OF PRIORITY

The present application is related to and claims priority to an application entitled “METHOD AND SYSTEM FOR CALL SWITCHING DURING MULTI-PARTY CALLING” filed in the Korean Intellectual Property Office on Jul. 17, 2008 and assigned Serial No. 10-2008-0069370, the contents of which are incorporated herein by reference.

### TECHNICAL FIELD OF THE INVENTION

The present invention relates generally to call switching during a multi-party call in a CDMA communication network and, more particularly, to a method and system for call switching during multi-party calling wherein in response to a call switch request from a mobile terminal, the base station provides a phone number associated with the newly selected counterpart to the mobile terminal so that the mobile terminal can display the phone number on the display unit.

### BACKGROUND OF THE INVENTION

The standards for code division multiple access (CDMA) systems including IS-95A, IS-95B and IS-2000 support multi-party calling. In multi-party calling, while a call is in progress, a subscriber can place or receive another call to or from a third party. Currently, commercially available systems permit up to three parties to talk in a single multi-party call.

In a CDMA system, call switching during multi-party calling can proceed as follows. First, it is assumed that a first mobile terminal is in call active state for conversation with a second mobile terminal through a base station, and a third to Nth mobile terminals are connected to the first mobile terminal and remain in call waiting state. To have a conversation with a third party during a call, the first mobile terminal sends a Flash With Information Message (FWIM) as a call switch request signal to the base station. The base station sends a reply to the first mobile terminal, and selects one of the third to Nth mobile terminals and places the call between the selected mobile terminal and the first mobile terminal in call active state. However, in this call switching process, as information on the selected mobile terminal is not supplied to the first mobile terminal, the user of the first mobile terminal may be unaware of the new counterpart.

According to the CDMA system specifications, call information is provided only when a call is initiated, and is not provided when call switching occurs. Hence, when the user is activated to one of multiple calls in waiting state, the user may be aware of the identity of the new counterpart only after the user hears the counterpart voice. This is because the base station sends a reply in return to a call switch request from a mobile terminal, but the reply is a message simply indicating the request reception and does not contain information regarding the new counterpart.

In particular, when multiple counterparts are in waiting state, to have a conversation with a desired counterpart, the user may be inconvenienced by having to repeatedly send a call switch request and hear the voice of one of the counterparts. Therefore, it is necessary to develop a technique to display call-related information for call switching during multi-party calling in a CDMA system.

### SUMMARY OF THE INVENTION

To address the above-discussed deficiencies of the prior art, it is a primary object to provide a method and system for call switching during multi-party calling in a CDMA system wherein the base station provides counterpart information including a phone number to a mobile terminal so that the user can readily be aware of the identity of the new counterpart.

In accordance with an exemplary embodiment of the present invention, there is provided a call switching method during multi-party calling, including: receiving, by a base station, a call switch request signal from a first mobile terminal; placing, by the base station in response to the call switch request signal, a second mobile terminal in call active state from call waiting state as to the first mobile terminal, and sending a call switch response signal containing number digit information of the second mobile terminal to the first mobile terminal; and extracting, by the first mobile terminal, number digit information contained in the received call switch response signal, and displaying the number digit information on a display unit.

In some embodiments of the present invention, the method and system provides the counterpart phone number to the user requesting call switching during multi-party calling, and hence the user does not have to enter into a conversation with an undesired counterpart to know the identity.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram for a multi-party call between multiple counterparts in a CDMA system;

FIG. 2 illustrates a block diagram of a mobile terminal with a call switching capability during multi-party calling according to an exemplary embodiment of the present invention;

FIG. 3 illustrates a sequence diagram for a method of call switching during multi-party calling according to another exemplary embodiment of the present invention;

FIG. 4 illustrates a flow chart for a procedure performed by a base station in the call switching method; and

FIGS. 5A to 5D illustrate information displayed on the display unit of the mobile terminal in the process of call switching during multi-party calling.

### DETAILED DESCRIPTION OF THE INVENTION

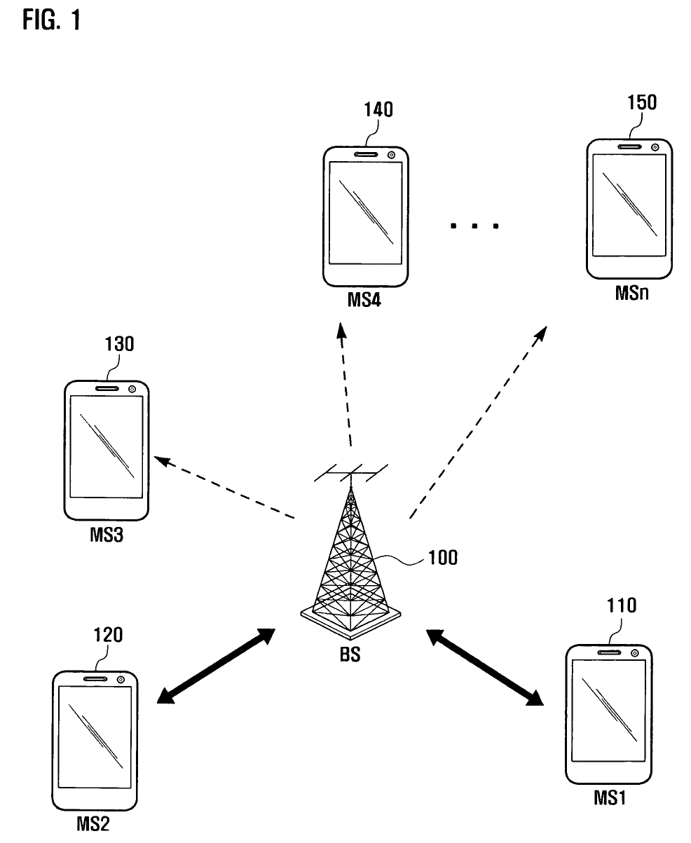

FIGS. 1 through 5D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

Particular terms may be defined to describe the invention in the best manner. Accordingly, the meaning of specific terms or words used in the specification and the claims should not be limited to the literal or commonly employed sense, but should be construed in accordance with the spirit of the invention.

In the description, multi-party calling indicates a case where, when a first subscriber is in call active state for conversation with a second subscriber, incoming calls from multiple third subscribers to the first subscriber are in call waiting state. For example, when a first user is in conversation with a second user, third to Nth users place a call to the first user and are in call waiting state, in which case the first to Nth users are in multi-party calling.

A call switch request signal is a signal transmitted as a FWIM defined in the CDMA system specification. The mobile terminal sends a call switch request signal to the base station to place the current call in call waiting state and activate another call in waiting state.

A call switch response signal is a signal transmitted as a FWIM as defined in the CDMA system specification. The base station sends a call switch response signal to the mobile terminal to make a reply to a received call switch request signal or to provide call information of a new counterpart.

In addition, a call switch response signal from the base station to the mobile terminal can include an indicator indicating whether the signal contains call information like a phone number of a new counterpart. This is detailed herein below.

FIG. 1 illustrates a block diagram for a multi-party call between multiple counterparts in a CDMA system.

Referring to FIG. 1, a first mobile terminal 110 connects to a base station 100 to communicate with second to Nth mobile terminals 120 to 150. That is, the first mobile terminal 110 is in a multi-party call with the second to Nth mobile terminals 120 to 150, wherein one of the second to Nth mobile terminals 120 to 150 is in call active state with the first mobile terminal 110 and the remaining ones are in call waiting state. In FIG. 1, broken lines indicate a call waiting state, and solid lines indicate a call active state.

The base station 100 is connected with the second to Nth mobile terminals 110 to 150, and relays and controls communication there between. Particularly, in response to a call switch request signal from the first mobile terminal 110, the base station 100 places the current call in the call waiting state, and selects one of the calls in the call waiting state and places the selected call in call active state. The base station 100 can send a call switch response signal to the first mobile terminal 110. The call switch response signal can contain phone number digits associated with the selected call together with an indicator of the phone number inclusion. Unlike a prior art system where a call switch response signal acts as a simple reply to a received call switch request signal and does not contain additional information, the base station 100 sends a call switch response signal containing a phone number of the new counterpart to the first mobile terminal 110 that then can display the phone number of the new counterpart on the display unit, thereby enabling the user thereof to visually identify the counterpart.

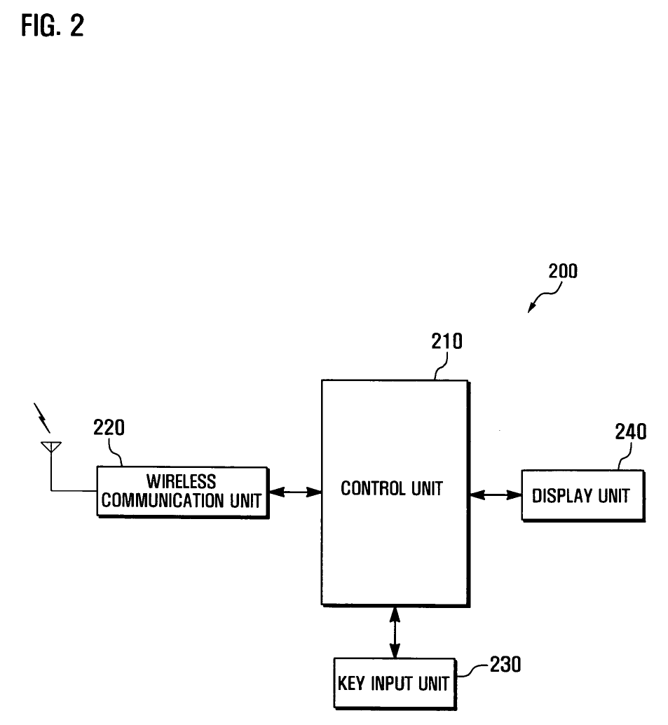

FIG. 2 illustrates a block diagram of a mobile terminal with a call switching capability during multi-party calling according to an exemplary embodiment of the present invention.

Referring to FIG. 2, the mobile terminal 200 includes a control unit 210, wireless communication unit 220, key input unit 230, and display unit 240. The control unit 210 can control an operation to generate a call switch request signal according to a user request, to extract phone number data from a call switch response signal received from a base station, and to display the extracted phone number data on the display unit 240.

The wireless communication unit 220 can send a call switch request signal generated by the control unit 210 to a base station, and receive from the base station a call switch response signal or a reply signal corresponding to a request signal. The key input unit 230 can send the control unit 210 an electrical signal for generating a call switch request signal in response to a user request. In particular, when the user presses a given key such as the ‘send’ key of the key input unit 230 during a multiparty calling, an electrical signal is generated and sent to the control unit 210 that then generates a call switch request signal.

The display unit 240 can display a phone number extracted by the control unit 210 from a call switch response signal.

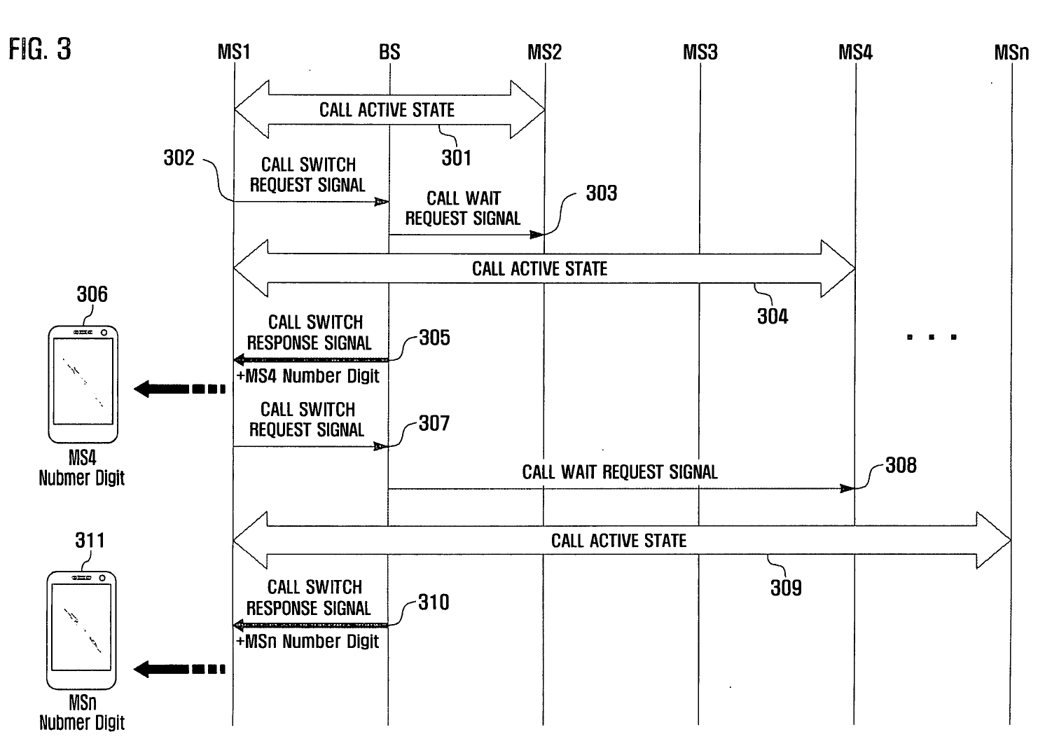

FIG. 3 illustrates a method of call switching during multi-party calling according to another exemplary embodiment of the present invention.

Referring to FIG. 3, a first mobile terminal MS1 is in conversation with a second mobile terminal MS2 through a base station BS and, as such, in a call active state 301. A third to Nth mobile terminals MS3 to MSn are in call waiting state. That is, the first mobile terminal MS1 is in multi-party calling with the second to Nth mobile terminals MS2 to MSn.

The first mobile terminal MS1 sends a call switch request signal 302 to the base station BS. In most cases, when the ‘call’ key or ‘send’ key is pressed, a call switch request signal is generated by the control unit and transmitted through the wireless communication unit to the base station. In the present invention, the first mobile terminal MS1 sends the call switch request signal 302 to the base station BS to request the base station BS to select one of calls in call waiting state and place the selected call in call active state.

The base station BS sends a call wait request signal 303 to the second mobile terminal MS2 in call active state for conversation with the first mobile terminal MS1. Thereafter, the base station BS places the second mobile terminal MS2 in call waiting state, and selects one of the calls in call waiting state and places the selected call in call active state 304. For example, the base station BS selects the fourth mobile terminal MS4 in call waiting state and places MS4 in the call active state 304.

Hence, the base station BS relays data transmission for the conversation between the first mobile terminal MS1 and fourth mobile terminal MS4.

In a CDMA system, a base station maintains information (for example, phone numbers) on mobile terminals engaged in multi-party calling. The base station BS sends a call switch response signal 305 containing information on the newly switched mobile terminal to the first mobile terminal MS1. That is, the call switch response signal 305 (a FWIM) contains the phone number digits of the fourth mobile terminal MS4, and further contains an indicator of phone number inclusion.

A call switch response signal 305 is described in more detail herein below. A call switch response signal 305 is transmitted as a FWIM as defined in the CDMA system specification.

A FWIM can contain one of various types of information records such as connected number information records. A connected number information record can include a number of fields as illustrated in Table 1. In particular, a FWIM used as a call switch response signal includes a newly defined value in the NUMBER_PLAN field of the Connected Number information record in order to force the base station BS to provide the phone number of, for example, the fourth mobile terminal MS4 to the first mobile terminal MS1.

TABLE 1

| Type-Specific Field | Length (bits) |
|---|---|
| NUMBER_TYPE | 3 |
| NUMBER_PLAN | 4 |
| PI | 2 |
| SI | 2 |

To be more specific, the NUMBER_PLAN field is a four-bit field in the Connected Number information record as shown in Table 1, and permissible values thereof defined in the CDMA system specification are listed in Table 2.

TABLE 2

| Description | NUMBER_PLAN (binary) |
|---|---|
| Unknown | 0000 |
| ISDN/Telephony numbering plan | 0001 |
| Data numbering plan | 0011 |
| Telex numbering plan | 0100 |
| Private numbering plan | 1001 |
| Reserved for extension | 1111 |

All other NUMBER_PLAN codes are reserved

To add the phone number of a newly switched call and an indicator of phone number inclusion to a call switch response signal 305 to be sent by the base station to a mobile terminal, a value denoting a new numbering plan (Choice numbering plan) is defined for the NUMBER_PLAN field as illustrated in Table 3. The newly defined value indicates inclusion of a phone number.

TABLE 3

| Description | NUMBER_PLAN (binary) |
|---|---|
| Unknown | 0000 |
| ISDN/Telephony numbering | 0001 |
| plan | |
| Data numbering plan | 0011 |
| Telex numbering plan | 0100 |
| Private numbering plan | 1001 |
| Choice numbering plan | 1110 |
| Reserved for extension | 1111 |

All other NUMBER_PLAN codes are reserved

As a consequence, the first mobile terminal MS1 receives, as a call switch response signal 305, a FWIM containing both the phone number of the fourth mobile terminal MS4 and a Connected Number information record whose NUMBER_PLAN field is set to ‘1110’ for indicating phone number inclusion. After reception of the call switch response signal, the first mobile terminal MS1 displays on the display unit the phone number of the fourth mobile terminal MS4 associated with the newly switched call in step 306.

In steps 307 to 311, the first mobile terminal MS1 sends a call switch request signal in step 307 to the base station BS, which then places the fourth mobile terminal MS4 in call waiting state in step 308 and places the Nth mobile terminal MSn in call active state in step 309 with the first mobile terminal MS1. These steps, e.g., steps 307-311 are similar to those steps, e.g., 302-305, for call switching from the second mobile terminal MS2 to the fourth mobile terminal MS4.

As described above, the newly defined value for an extensible field of the CDMA system specification enables the user of the first mobile terminal MS1 to visually identify the counterpart through a displayed phone number, instead of hearing the voice of the counterpart. It is evident to those skilled in the art that the new numbering plan (“Choice numbering plan”) may be given a different name and be assigned any unused four-bit value other than ‘1110’.

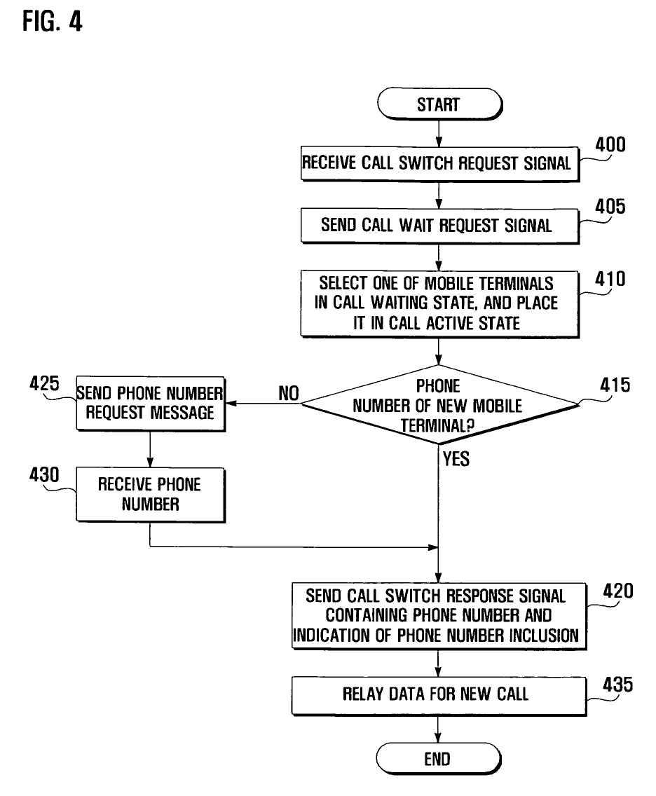

FIG. 4 illustrates a flow chart for a procedure performed by a base station in the call switching method.

Referring to FIG. 4, the base station receives a call switch request signal from the first mobile terminal in step 400. The base station sends a call wait request signal to the second mobile terminal in conversation with the first mobile terminal in step 405. Thereafter, the second mobile terminal is placed in call waiting state from call active state. The base station selects one of the third to Nth mobile terminals in call waiting state, and places the selected mobile terminal in call active state in step 410. For the purpose of description, it is assumed that the fourth mobile terminal is selected and placed in call active state.

The base station checks the presence of phone number information of the fourth mobile terminal in step 415. As the fourth mobile terminal provides its own information to the base station when it makes a call to the first mobile terminal, the base station can already have the information on the fourth mobile terminal. If phone number information of the fourth mobile terminal is present, the base station sends the first mobile terminal a call switch response signal containing both the phone number information of the fourth mobile terminal and an indicator of the phone number inclusion in step 420, and proceeds to step 435.

If phone number information of the fourth mobile terminal is not present, the base station sends a phone number request message to the fourth mobile terminal in step 425. After receiving phone number information from the fourth mobile terminal in step 430, the base station sends the first mobile terminal a call switch response signal containing both the phone number information of the fourth mobile terminal and an indication of the phone number inclusion in step 420.

Thereafter, the base station relays call data transmission for the conversation between the first mobile terminal and fourth mobile terminal, and keeps the other mobile terminals in call waiting state in step 435.

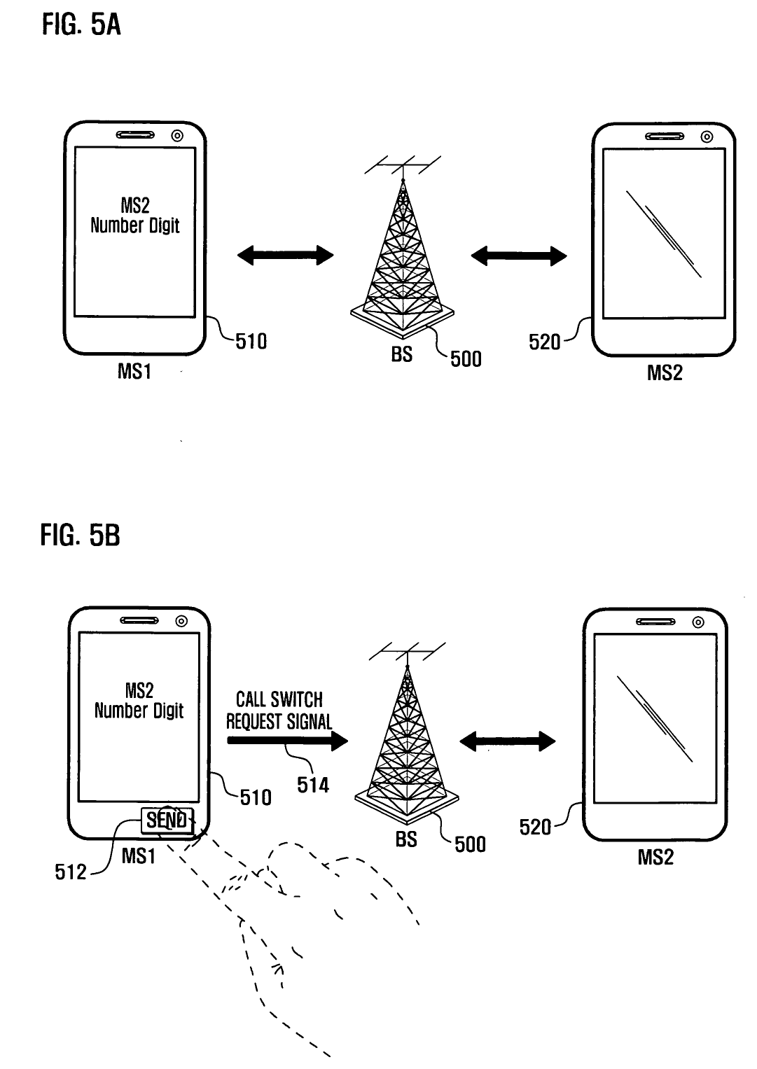

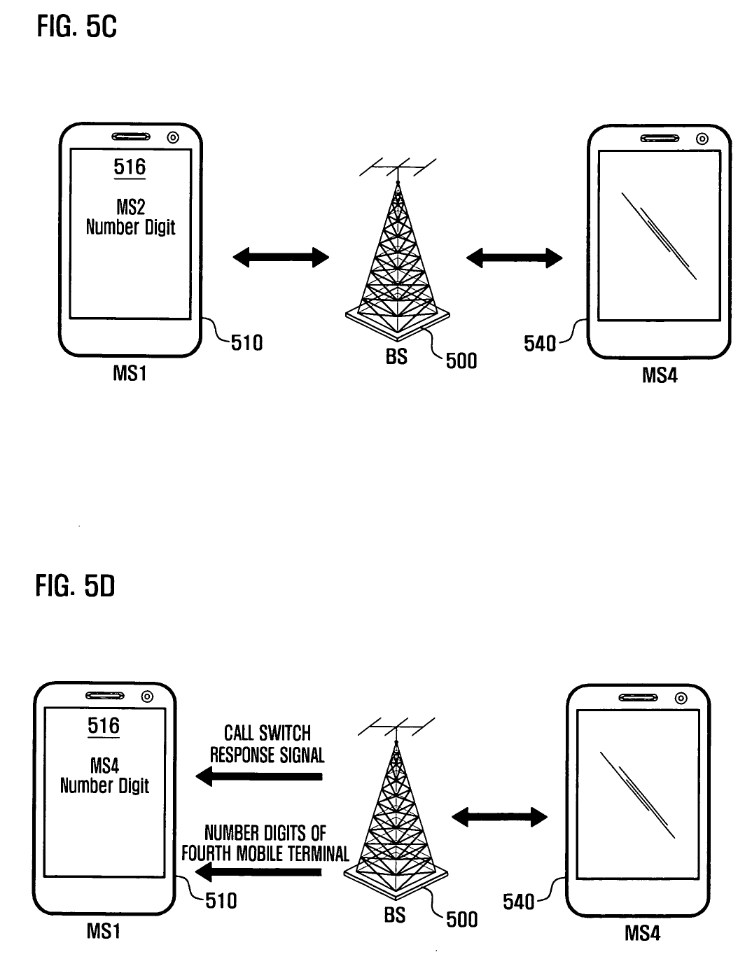

FIGS. 5A to 5D illustrate information displayed on the display unit of the mobile terminal in the process of call switching during multi-party calling.

In FIG. 5A, the first mobile terminal MS1 510 is in call active state for conversation with the second mobile terminal MS2 520 through the base station BS 500. When the user of the first mobile terminal MS1 510 inputs the ‘send’ key 512 as shown in FIG. 5B, the first mobile terminal MS1 505 sends a call switch request signal 514 in the form of a FWIM to the base station BS 500.

In FIG. 5C, the call between the first mobile terminal MS1 510 and the fourth mobile terminal MS4 540 is changed from call waiting state to call active state. Although not shown, as described before, the second mobile terminal MS2 520 is placed in call waiting state from call active state by a call wait request signal. However, as information of the fourth mobile terminal MS4 540 has not yet arrived, information of the second mobile terminal MS2 520 is displayed on the display unit 516 of the first mobile terminal MS1 510.

Finally in FIG. 5D, the base station BS 500 sends the first mobile terminal MS1 510 a FWIM containing both the phone number of the fourth mobile terminal MS4 540 and an indicator of phone number inclusion, as a call switch response signal. Upon reception of the FWIM, the first mobile terminal MS1 510 can be aware of phone number inclusion by checking the NUMBER_PLAN field set to ‘1110’ in the Connected Number information record, and display the phone number of the fourth mobile terminal MS4 540 on the display unit 516.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A call switching method during multi-party calling, comprising:
receiving, by a base station, a call switch request signal from a first mobile terminal;
placing, by the base station in response to the call switch request signal, a second mobile terminal in call active state from call waiting state as to the first mobile terminal; and
sending a call switch response signal containing number digit information of the second mobile terminal to the first mobile terminal; wherein call switch response signal comprises a number digit information configured to be extracted and displayed by the first mobile terminal.

2. The call switching method of claim 1, further comprising placing, by the base station after receiving the call switch request signal, a third mobile terminal communicating with the first mobile terminal in call waiting state.

3. The call switching method of claim 1, wherein extraction of number digit information is performed after checking an indication of number digit inclusion in the received call switch response signal.

4. The call switching method of claim 1, wherein the call switch request signal is a flash with information message.

5. The call switching method of claim 3, wherein the indication of number digit inclusion is given by an extensible field of a Connected Number information record contained in a flash with information message.

6. The call switching method of claim 5, wherein call switching is performed on a CDMA communication network.

7. A communication system comprising:
a first mobile terminal;
a second mobile terminal in call waiting state as to the first mobile terminal;
a third mobile terminal in call active state as to the first mobile terminal; and
a base station controlling call switching for the first mobile terminal,
wherein when a call switch request signal is received from the first mobile terminal, the base station places the second mobile terminal in call active state and sends a call switch response signal containing number digit information of the second mobile terminal to the first mobile terminal, and the first mobile terminal extracts number digit information contained in the received call switch response signal and displays the extracted number digit information on a display unit.

8. The communication system of claim 7, wherein the base station places the third mobile terminal in call waiting state after receiving the call switch request signal.

9. The communication system of claim 8, wherein the first mobile terminal extracts number digit information after checking an indication of number digit inclusion in the received call switch response signal.

10. The communication system of claim 7, wherein the call switch request signal is a flash with information message.

11. The communication system of claim 9, wherein the indication of number digit inclusion is given by an extensible field of a Connected Number information record contained in a flash with information message.

12. The communication system of claim 11, wherein call switching is performed on a CDMA communication network.

13. A mobile terminal capable of:
transmitting a call switch request signal while in a call active state as to a first terminal;
receiving a call switch response signal containing a number digit information of a second terminal;
extracting the number digit information contained in the received call switch response signal; and
displaying the extracted number digit information on a display unit.

14. The mobile terminal of claim 13, wherein a base station after receiving the call switch request signal, places the first terminal in a call waiting state.

15. The mobile terminal of claim 13, wherein a base station after receiving the call switch request signal, places the second terminal in a call active state as to the mobile terminal.

16. The mobile terminal claim 13, wherein extracting the number digit information is performed after checking an indication of number digit inclusion in the received call switch response signal.

17. The mobile terminal of claim 13, wherein the call switch request signal is a flash with information message.

18. The mobile terminal claim 16, wherein the indication of number digit inclusion is given by an extensible field of a Connected Number information record contained in a flash with information message.

19. The mobile terminal of claim 18, wherein call switching is performed on a CDMA communication network.

20. The mobile terminal of claim 18, wherein a base station selects the second terminal from a plurality of terminals in a call waiting with the mobile terminal.
